(19) United States
(12) Patent Application Publication
(10) Pub. No.: US 2010/0147275 A1
(43) Pub. Date: Jun. 17, 2010

(54) Ignition coil, in particular for an internal combustion engine of a motor vehicle

(76) Inventor: Alwin Stegmaier, Blaichach (DE)

Correspondence Address: KENYON & KENYON LLP, ONE BROADWAY, NEW YORK, NY, 10004, US

(21) Appl. No.: 12/311,400

(22) PCT Filed: Sep. 12, 2007
(86) PCT No.: PCT/EP2007/059568

§ 371 Date: Sep. 29, 2009

(30) Foreign Application Priority Data
Sep. 26, 2006 (DE) 10 2006 045 356.5

(51) Int. Cl. H01F 38/12

(52) U.S. Cl. 123/634

(57) ABSTRACT

An ignition coil, in particular for an internal combustion engine of a motor vehicle, has an inner magnet core, which is concentrically surrounded by a primary coil and a secondary coil. The inner magnet core acts together with an outer C-shaped magnet core. To minimize the size of the ignition coil, a provision is made in particular to adapt the height of the outer magnet core to the height of the secondary coil. It is furthermore provided to develop the outer magnet core from multiple sheet metal elements, which may be manufactured by a punching/bending process. This makes it possible to achieve a particularly cost-effective manufacture.

### BACKGROUND INFORMATION

An ignition coil is described in German Patent No. DE 10 2004 038 799. In the ignition coil, the C-shaped development of the outer magnet core of the ignition coil creates an installation space for a switching module within the housing on the side facing away from the outer magnet core. Furthermore, in the ignition coil, the coil shell, due to its design, also requires an enlarged installation space on the side across from the outer magnet core. The outer magnet core has a rectangular cross-sectional area, the height of which corresponds approximately to the height of the inner magnet core that has a square cross-sectional area. Due to the fact that the cross-sectional area of the outer magnet core is markedly reduced compared to that of the inner magnet core, the magnetic properties of the known ignition coil are not optimal as compared to a system having a closed O-shaped outer magnet core having accordingly a cross-sectional area that is twice as large. Furthermore, because of the relatively small overall height of the outer magnet core, a relatively large amount of insulating resin is required to fill the housing, which additionally results in a relatively large size of the ignition coil housing or the ignition coil.

### SUMMARY OF THE INVENTION

The ignition coil according to the present invention, in particular for an internal combustion engine of a motor vehicle, has the advantage that, compared to an O-shaped outer magnet core, it is possible to achieve a reduced required space for the ignition coil and at the same time good magnetic properties.

A minimization or optimization of the required space of the ignition coil may be achieved if the height or extension of the outer magnet core corresponds to the height or extension of the outer coil shell. Thus the entire overall height of the ignition coil in the ignition coil housing entailed by the size of the outer of the two coil shells is utilized, which makes it possible to reduce the thickness of the outer magnet core for a given cross-sectional area of the outer magnet core.

A particularly economical manufacture of the outer magnet core may be achieved if it is made up of multiple sheet metal elements stacked one behind another or one above the other, the shanks of the outer magnet core being formed by a bending process from its central region.

Another advantageous specific embodiment provides for situating the coil shells having a rectangular cross-sectional area transversely with respect to the longitudinal extension of the ignition coil in the housing in order to reduce the overall height of the ignition coil.

To simplify the installation process of the outer magnet core, it is furthermore advantageous to develop one of the two shanks of the outer magnet core so as to have a recess, in particular a notch. This makes it very simple to connect the inner magnet core with the outer magnet core in a form-locking manner without placing particular requirements on the component tolerance of the inner magnet core.

### BRIEF DESCRIPTION OF THE DRAWINGS

FIG. 1 shows a longitudinal section through a first ignition coil according to the present invention.

FIG. 2 shows a top view of the ignition coil shown in FIG. 1.

FIG. 3 shows a longitudinal section of an ignition coil according to the present invention that is modified with respect to FIG. 1.

FIG. 4 shows a modified magnet core setup in a simplified top view.

FIG. 5 shows a section in the V-V plane of FIG. 4.

### DETAILED DESCRIPTION

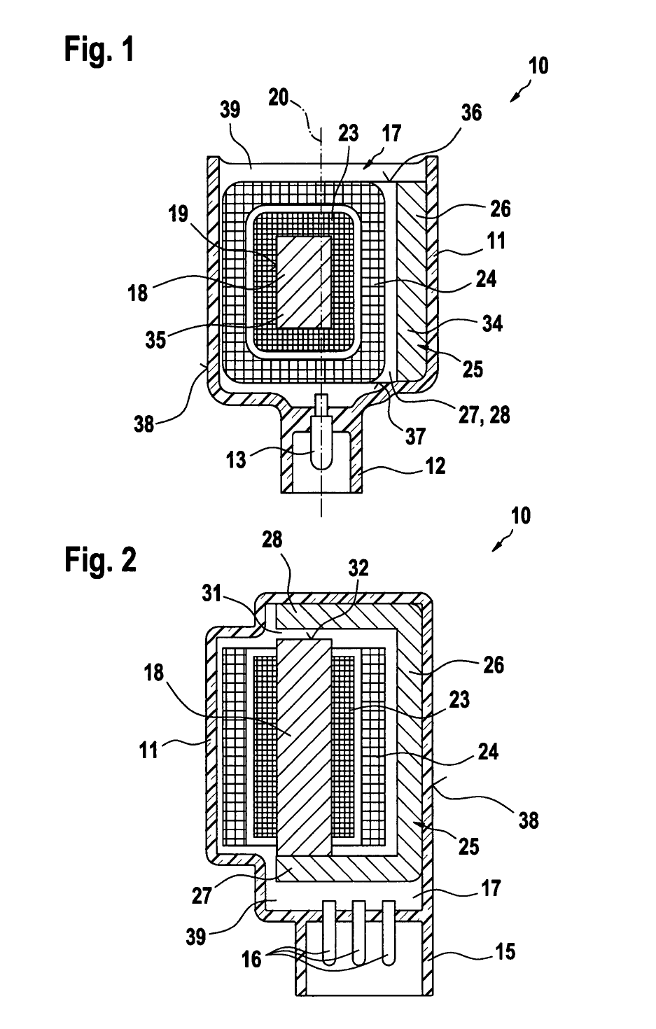

The ignition coil 10 shown in FIGS. 1 and 2 in a simplified manner is used to contact directly a spark plug (not shown) of an internal combustion engine in a motor vehicle. Ignition coil 10 has a pot-shaped or beaker-shaped housing 11. In its lower region, the housing 11 made of plastic has a segment 12 that is reduced in diameter having a high-voltage terminal 13 (only indicated schematically) that is capable of contacting the spark plug. Laterally in its upper region, housing 11 has a plug connector 15 integrally formed on housing 11 having multiple plug connector pins 16.

A rod-shaped inner magnet core 18 that is rectangular in its cross section is situated in the interior 17 of housing 11. The longer side 19 of inner magnet core 18 runs parallel with respect to longitudinal axis 20 of ignition coil 10. Inner magnet core 18 is concentrically surrounded by a primary coil 23 and a secondary coil 24. Primary coil 23 and secondary coil 24 each have an oblong form extending in the direction of longitudinal axis 20. Primary coil 23 includes in the usual manner a primary coil shell and a primary wire, and secondary coil 24 includes a secondary coil shell and a secondary wire. Primary coil 23 or its primary wire are in electrical contact with the on-board voltage of the motor vehicle in the usual manner via plug connector pins, while secondary coil 24 or its secondary wire is connected to high-voltage terminal 13.

The two end face segments of inner magnet core 18 protrude somewhat beyond the end faces of primary coil 23 and secondary coil 24 (FIG. 2).

To form a close magnetic circuit, inner magnet core 18 acts together with an outer magnet core 25 that is essentially C-shaped. Outer magnet core 25 has a central base segment 26 adapted to the length of inner magnet core 18, from which two shanks 27, 28 proceed at right angles. The end region of the one shank 27 connects directly to the one end face of inner magnet core 18. The end region of the other shank 28 is set apart by an air gap 31 from end face 32 of inner magnet core 18 (FIG. 2).

Outer magnet core 25 is dimensioned in such a way that its cross-sectional area 34 corresponds at least approximately to cross-sectional area 35 of inner magnet core 18. As may be seen from FIG. 1, the height of base segment 26 and the height of shanks 27 and 28 are furthermore dimensioned such that upper side 36 and lower side 37 of outer magnet core 25 terminate with (outer) secondary coil 24. At the predefined height of outer magnet core 25 or the extension of secondary coil 24, the thickness of base segment 26 or of shanks 27 and 28 results from the fact that cross-sectional areas 34 and 35 are to be approximately equal.

As may be seen from an overall view of FIGS. 1 and 2, and particularly from FIG. 2, the contour 38 of housing 11 is adapted to the shape of the components located in the interior 17 of housing 11. In particular, contour 38 is adapted to the shape and size of the components directly bordering on housing 11, that is, to outer magnet core 25 and secondary coil 24. This results in relatively small spaces or gaps and volumes in interior 17 between housing 11 and the components bordering on it.

Following the installation in interior 17, the latter is filled with an insulating resin 39. As a result of the mentioned adaptation of contour 38 of housing 11 to the shape of the components and the height of outer magnet core 25 which corresponds to the height of (outer) secondary coil 24, it is thus possible to minimize the required quantity of insulating resin 39 and to optimize the size of ignition coil 10.

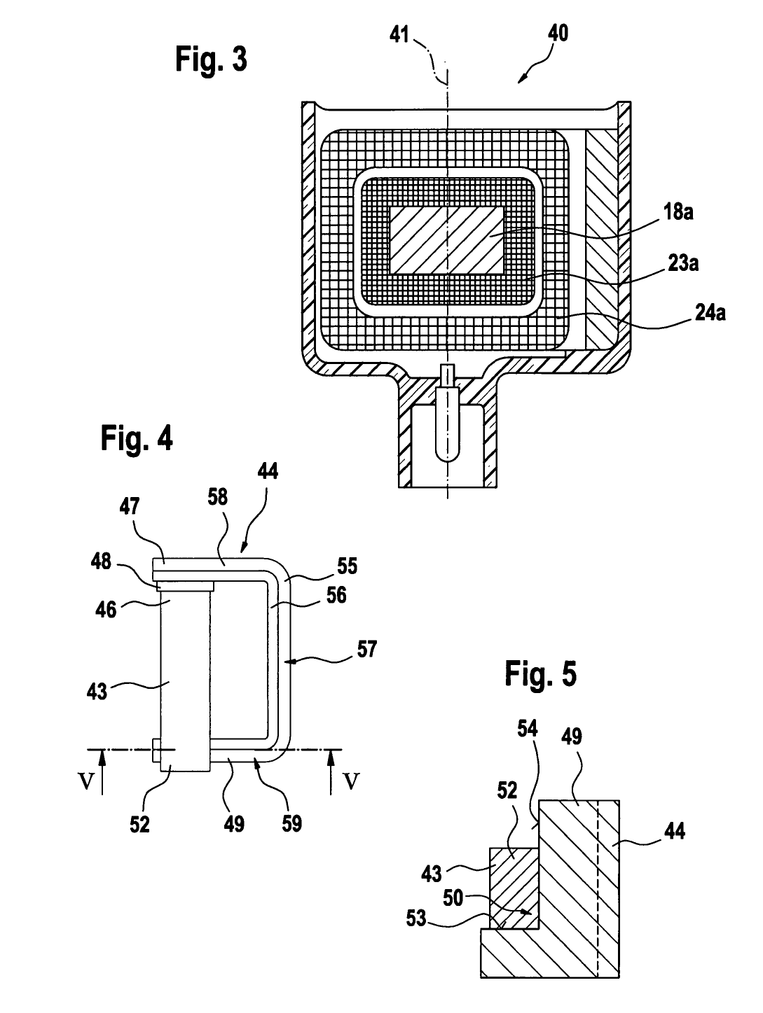

In contrast to the exemplary embodiment shown in FIGS. 1 and 2, in the exemplary embodiment shown in FIG. 3, a minimization of the overall height of ignition coil 40 may be achieved. This is done in that the inner magnet core 18a having a rectangular cross section, primary coil 23a and secondary coil 24a are situated, in terms of their respective longitudinal extension, transversely with respect to longitudinal axis 41 of ignition coil 40.

FIGS. 4 and 5 show a magnetic circuit that is modified with respect to FIGS. 1 through 3. Besides inner magnet core 43, this magnetic circuit includes again a C-shaped outer magnet core 44. In contrast to the two first exemplary embodiments, however, a permanent magnet element 48 is situated between the one first end region 46 of inner magnet core 43 and the shank 47 of outer magnet core 44 situated across from end region 46, which permanent magnet element 48 is in direct contact with inner magnet core 43 and outer magnet core 44. In order to allow for an installation that is largely independent of the tolerance of inner magnet core 43 and outer magnet core 44, the other shank 49 is developed to have a recess, in particular a notch 50. As is best seen in FIG. 5, second end region 52 of inner magnet core 43 rests on one side 53 of notch 50 and at the same time abuts on a lateral surface 54 of outer magnet core 44. Furthermore, end region 52 protrudes somewhat beyond the outside of shank 49. It is important for the size and the positioning of the recess or notch 50 that the abutting or supporting surface of inner magnet core 43 on outer magnet core 44 corresponds at least to the cross-sectional area of inner magnet core 43. This ensures that the magnetic flux both over inner magnet core 43 as well as outer magnet core 44 always runs over the same cross-sectional area, that there are not constrictions of the cross section for the magnetic flux lines, and that thus an optimization is achieved.

Further, FIG. 4 shows that outer magnet core 44 is made of, in the exemplary embodiment, two sheet metal elements 55, 56 lying closely one behind the other. Each of the sheet metal elements 55, 56 is produced by a punching process from a metal sheet, the shape of notch 50 already having been taken into account in the process. From the plane punched sheet metal part thus formed, the two shanks 58, 59 are bent away from base segment 57 in a bending step. Such a manufacture of outer magnet core 44 may be effected in an economically particularly advantageous manner, the lower the number of sheet metal elements 55, 56. Such a relatively cost-effective manufacture, however, only results from the fact that the overall height of secondary coil 24 may be utilized for the cross-sectional area of outer magnet core 44 because the special geometric development makes it possible to minimize the thickness of sheet metal elements 54, 55 (important for the question of deformability) as well as their number (important for the number of work steps).

The development of outer magnet core 44 shown in FIGS. 4 and 5 may of course also be applied to the two exemplary embodiments shown in FIGS. 1 through 3. It shall be additionally mentioned that the examples shown in the exemplary embodiments are based on the assumption that the height of the outer magnet core is respectively adapted to the overall height or extension of the (outer) secondary coil. A reduction of the size of an ignition coil may already be achieved, however, as soon as the overall height of the outer magnet core is greater in relation to the longitudinal axis of the ignition coil than that of the inner magnet core.

1-8. (canceled)

9. An ignition coil for an internal combustion engine of a motor vehicle, comprising:
a primary coil;
a secondary coil;
an inner magnet core, which is concentrically surrounded by the primary coil and the secondary coil;
an outer C-shaped magnet core, end regions of shanks of which, which shanks stick out from a base segment, are situated in magnetic operative connection with ends of the inner magnet core; and
a housing for accommodating components, which is filled with an insulating compound that fills interstices between the components,
wherein a cross-sectional area of the outer magnet core corresponds at least substantially to a cross-sectional area of the inner magnet core and an extension of the outer magnet core with respect to a longitudinal axis of the ignition coil is greater than an extension of the inner magnet core.

10. The ignition coil according to claim 9, wherein the inner magnet core is rod-shaped.

11. The ignition coil according to claim 9, wherein the extension of the outer magnet core with respect to the longitudinal axis of the ignition coil corresponds to a height of an outer one of two coils of the primary coil or the secondary coil.

12. The ignition coil according to claim 9, wherein the outer magnet core is made up of multiple sheet metal elements, a length of which is adapted to a length of the shanks and of the base segment of the outer magnet core and the shanks are formed from the base segment by a bending process.

13. The ignition coil according to claim 9, wherein the primary coil and the secondary coil each have an oblong shape and a longitudinal extension of the primary coil and the secondary coil runs transversely with respect to the longitudinal axis of the ignition coil.

14. The ignition coil according to claim 9, wherein at least one of two shanks of the outer magnet core has a receptacle for an end region of the inner magnet core.

15. The ignition coil according to claim 14, wherein the receptacle is a notch.

16. The ignition coil according to claim 9, further comprising, on one end face of the inner magnet core, a permanent magnet element connecting to an inside of one of the shanks of the outer magnet core.

17. The ignition coil according to claim 9, wherein a contour of the housing is adapted to a size and shape of the components spaced in an interior directly adjacent to the housing.
